(19) United States
(12) Patent Application Publication
(10) Pub. No.: US 2015/0204202 A1
(43) Pub. Date: Jul. 23, 2015

(54) TURBINE ROTOR OF AN EXHAUST-GAS TURBOCHARGER

(71) Applicant: Schaeffler Technologies AG & Co. KG, Herzogenaurach (DE)

(72) Inventor: Klaus Daut, Herzogenaurach (DE)

(73) Assignee: SCHAEFFLER TECHNOLOGIES AG & CO. KG, Herzogenaurach (DE)

(21) Appl. No.: 14/423,545

(22) PCT Filed: Jun. 13, 2013
(86) PCT No.: PCT/EP2013/062205

§ 371 Date: Feb. 24, 2015

(30) Foreign Application Priority Data
Aug. 28, 2012 (DE) 10 2012 215 248.2

(51) Int. Cl. F01D 5/30; F02B 47/08

(52) U.S. Cl. CPC F01D 5/30; F02B 47/08

(57) ABSTRACT

A turbine rotor of an exhaust-gas turbocharger of an internal combustion engine is provided, having at least one rotor disk (2, 3) configured as a turbine wheel and/or a compressor wheel, and a shaft (4), which is made of different materials. The hub (7) of the rotor disk (2, 3) is durably connected to the shaft (4) by way of a screw assembly (5, 6). An outer screw thread (9) of an axially protruding hub appendage (8) of the rotor disk (2, 3) for receiving a shaft nut (10) connected to the shaft (4) is provided therefor. In a final position, the shaft nut (10) is centered on a cone (12) of the hub appendage (8).

### BACKGROUND

The invention relates to a turbine rotor of a turbocharger of an internal combustion engine and to a method for forming a turbine rotor.

Turbochargers, especially exhaust-gas turbochargers, are provided for increasing the power of internal combustion engines by utilizing the energy in the exhaust gas.

Exhaust gas turbochargers have rotor disks that are connected by means of a shaft supported within a bearing housing of the exhaust gas turbocharger. A first rotor disk, the turbine wheel driven by the exhaust gas flow of the internal combustion engine, is connected by the shaft to a second, compressor wheel allocated to the intake system of the internal combustion engine. The compressor wheel increases the pressure, which means more oxygen is taken into the intake system and a greater amount of fuel can be injected, leading to an increase in power from the internal combustion engine. For approximately the same dimensions, the exhaust gas turbocharger makes it possible to significantly increase the output and the maximum torque of the internal combustion engine. A shaft connects the turbine rotor to the compressor wheel, which together form a turbine rotor. When exhaust gas turbochargers are operating, rotational speeds of >250,000 rpm can occur. At these rotational speeds, the compressor wheel and/or the turbine wheel are elongated radially and shortened axially due to the centrifugal forces, which can produce a change in balance. A change in balance also causing whistling noises can further lead to complete failure of the turbocharger, as well as damage to the internal combustion engine. Due to this component loading, a secure connection of all components of the turbine rotor is necessary to allow fault-free operation of the turbocharger. The rotor fastening on the shaft of the turbine rotor is therefore decisive for the reliability of the exhaust gas turbocharger.

From the prior art it is known to connect the individual components of the turbine rotor to each other with a positive substance fit, for example, by friction welding or laser welding. The subsequent cooling of the weld connection can cause different heat transitions of the components produced from different materials. Therefore, these methods require costly thermal aftertreatment and subsequent crack testing.

EP 1 502 008 B1 discloses a turbine rotor of an exhaust gas turbocharger whose shaft connects two rotors, a turbine wheel and a compressor wheel, and is supported in bearings of the exhaust gas turbocharger housing. Each rotor comprises a hub appendage with a central recess provided for mounting the shaft and a bushing connected to it. One bushing performing a sealing and holding function is enclosed on the outside by a crimp sleeve that is connected by crimping or shrinking to the hub appendage by a non-positive fit.

### SUMMARY

One objective of the invention is to create a secure connection between the components of the rotor shaft created from different materials, with a durable design, simple assembly, and low costs.

This objective is met by a turbine rotor and a method for forming a turbine rotor with one or more features of the invention. Preferred constructions of the invention are described below and in the claims.

According to one embodiment, the shaft and the rotor disk or the rotor disks are joined for realizing a durable connection by means of a screw assembly, wherein an external thread of an axially projecting hub appendage of the rotor disk is designed for holding a shaft bushing or shaft nut connected integrally to the shaft. In an end position in which the components produced from different materials are screwed together tightly, the shaft nut is centered on a cone of the hub appendage. The screw assembly according to the invention for the components made from different materials in the turbine rotor can be produced easily, assembled without a problem, and thus can be realized economically. Advantageously, the rotor disks are centered and fixed relative to the shaft by the joint connection according to the invention. The centering improves the positioning, especially the coaxiality and right-angle orientation of the rotor disks constructed as a turbine wheel and a compressor wheel relative to the shaft, which has an advantageous effect on the service life. The screw assembly according to the invention is suitable for continuously withstanding or transmitting potentially high forces or torques that occur. If necessary, the joint connection also allows mechanical final processing of all components of the turbine rotor, for example, a RaAx turbine rotor (turbine rotor with vanes profiled in the radial and axial directions), or balancing of the turbine rotor. The threaded connection according to the invention and designed for the problem advantageously also guarantees a positive-fit and non-positive-fit connection that can be reliably and correctly processed even at the temperature differences of ˜400 K (−130°) that can occur between the components of the turbine rotor produced from different materials. The measures according to the invention also allow desirably narrower production and dimensional tolerances that have favorable effects on the operation of the exhaust gas turbocharger designed for rotational speeds of 250,000 rpm.

For the components of the turbine rotor produced from different materials, it is preferable to produce the rotor disk from an iron-free material and the shaft from steel. The turbine wheel and compressor wheel of the turbine rotor, including the axially projecting hub appendage, can preferably be made from Inconel or a comparable high temperature-resistant material in a fine casting method. Then rework is performed in which, for example, in a metal-cutting process, the external thread, a cone, and a notch or a ring groove is produced on the hub appendage before the rotor disks are connected to the shaft to form one unit, the turbine rotor. After this, final processing of the turbine rotor is performed in which at least individual components are processed to achieve optimum running quality of the rotor.

The external thread for the hub appendage is constructed according to the invention as a flat trapezoidal thread. Preferably, the flat American trapezoidal thread 5/16 14 STUB ACME is suitable for this purpose, which can be used for transmitting large forces that produce, for example, at high accelerations, a fast run-up of the exhaust gas turbocharger. Furthermore, this external thread, which interacts with a corresponding internal thread of the shaft nut with a positive fit on the entire thread length, prevents loosening due to oscillations or vibrations transmitted by the internal combustion engine or typically generated in exhaust gas turbochargers. The selected trapezoidal thread is ideal for the produced size relationships on the hub appendage of the rotor disks. Due to the dimensional conditions of the hub appendage, the screw assembly can be restricted to a max. 2 thread turns, in order to create a compact, installation space-optimized joint connection that has sufficient dimensions for a durable connection. If necessary, obviously a threaded connection could be used that encloses more than 2 load-carrying thread runs. Furthermore, the invention is not limited to the thread named above. Alternatively, for example, a flat trapezoidal thread according to DIN 380 could be used. In addition, according to the invention, other thread shapes, for example, a metric ISO thread (DIN 13) or a Whitworth thread could be used, which have right-hand or left-hand tapping designs.

According to the invention, the flat trapezoidal thread is formed in the hub appendage and in the shaft nut by a circular milling process. The circular thread milling was developed for machining centers especially for short threads and certain materials. The circular thread millers used here have high durability, so that flat trapezoidal threads can be manufactured in a reproducible manner and high manufacturing quality. The circular milling could be replaced according to the invention by a conventional milling process or by another suitable metal-cutting process with which the required toothed section quality can be produced for the screw assembly.

For the structural design of the hub appendage of the rotor disks, the following dimensions are suitable: for the length S≦12 mm and for the diameter D≦10 mm. As optimization measures, for the length S≦9 mm and for the diameter D≦8 mm have proven especially advantageous. The hub appendage thus has relatively small dimensions, which advantageously reduces the required material use of the temperature-resistant, cost-intensive material. The invention, however, is not restricted to the dimensions of the hub appendage mentioned above.

For the centering of the shaft also provided according to the invention, on the hub appendage there is a cone that is advantageously produced after the circular milling processing step for the external trapezoidal thread. Advantageously, the cone connects to the external thread of the hub appendage, wherein the shaft can also be centered, for example, on a cone arranged on the end side of the hub appendage. The structural cone design provides that the cone increasing toward the hub of the rotor disk has a length of ≦1.5 mm and an angle a of ≦35°. According to one preferred construction, the cone is limited to a length of 1 mm and forms an angle of approx. 25 degrees. The rotor disk centered on the shaft by a cone arrangement causes a desired right-angle orientation and simplifies the balancing of the turbine rotor.

Corresponding to the external thread of the hub appendage, an internal thread is formed in the blind hole-like hole of the shaft nut of the shaft that produces a connection between the rotor disks of the turbine rotor. In addition, the shaft nut has an end-side mount that has a design complementary to the cone of the hub appendage.

For securing the screw assembly and the centering, a notch formed as a ring groove in the hub appendage is arranged after the cone. After the hub appendage has been fastened with the shaft nut, at least partial flanging of a flanged collar is produced from the shaft material in the notch. For effective securing of the screw assembly, a flanging of approx. 0.4 mm is sufficient as the circumference.

The method relates to a permanent joining of a shaft to at least one rotor disk of a turbine rotor that is used in an exhaust gas turbocharger of an internal combustion engine and comprises the following steps: A) Processing the rotor disk: First an external thread is created on the axially projecting hub appendage of the rotor disk by a circular thread milling method. Then a cone and a notch or a ring groove is formed in a section of the hub appendage of the rotor risk arranged after the external thread. B) Processing the shaft: First an internal thread is formed in the blind hole of the shaft nut by a circular thread milling method and also a mount corresponding to the cone of the hub appendage on the end side. C) Joining of the rotor disk and shaft by means of a screw assembly: For the positive fit and non-positive fit connection, the shaft nut is fastened on the eternal thread of the rotor disk. In sync with the tightening of the screw assembly with a defined tightening torque, a centering of the joined components is performed by engaging the cone of the hub appendage with a positive fit in the mount of the shaft nut. Finally the screw assembly is secured by a flanging process in which a flanged collar of the shaft material is formed into the ring groove of the hub appendage.

### BRIEF DESCRIPTION OF THE DRAWINGS

Additional features of the invention are given in the following description of the figures in which an embodiment of the invention is shown, wherein the invention does not limit this embodiment. Shown are:

FIG. 1 a turbine rotor in a detail drawing including a shaft to which a rotor disk is allocated on each end side,

FIG. 2 a rotor disk in a detail drawing,

FIG. 3 the hub appendage in a view according to detail A of FIG. 2,

FIG. 4 at an enlarged scale, the hub appendage according to FIG. 3,

FIG. 5 the shaft of the turbine rotor in longitudinal section,

FIG. 6 the detail B according to FIG. 5 at an enlarged scale.

### DETAILED DESCRIPTION OF THE PREFERRED EMBODIMENTS

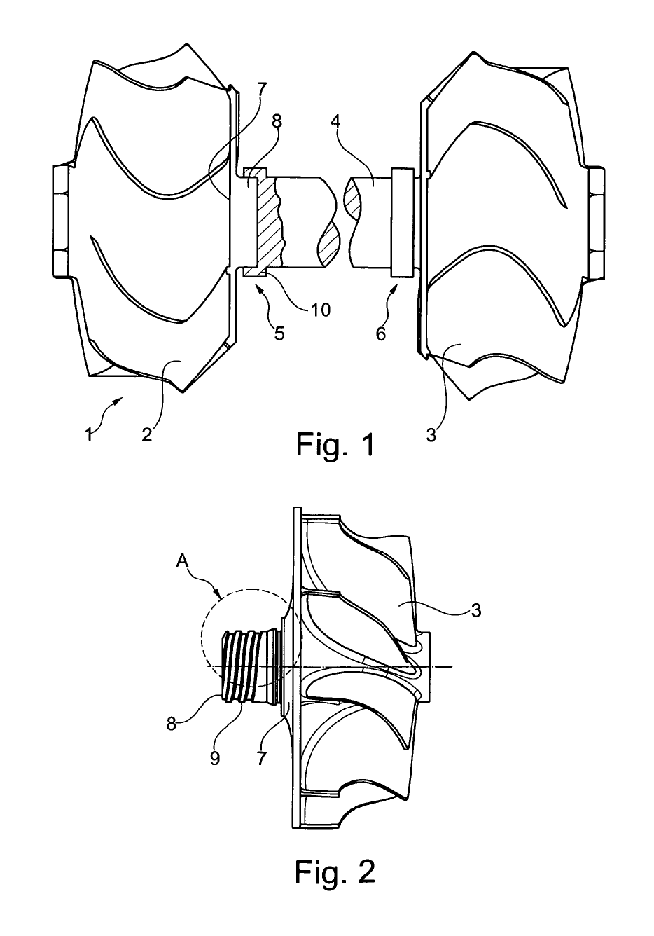

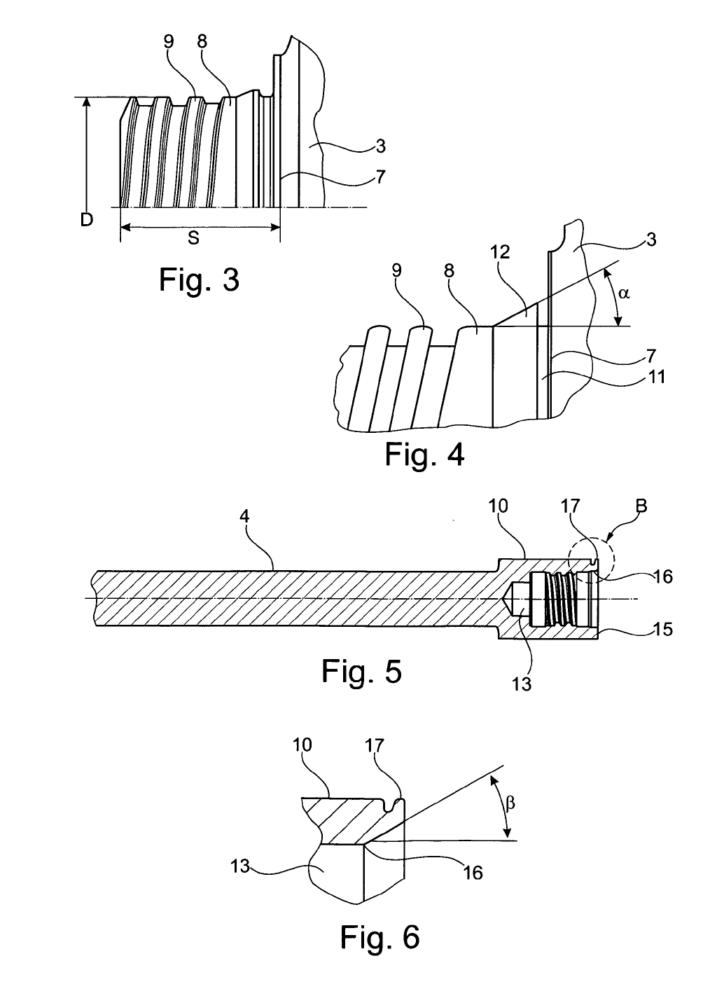

FIG. 1 shows a turbine rotor 1 including two rotor disks 2, 3 that are formed as a turbine wheel and compressor wheel, respectively, and are connected by a shaft 4. The shaft 4 connecting the two rotor disks 2, 3 to each other is supported in a not-shown housing of an exhaust gas turbocharger so that it can rotate. The rotor disks 2, 3 are each connected to the shaft 4 by a screw assembly 5, 6. For this purpose, each rotor disk 2, 3 forms, in the region of a hub 7, an axially projecting hub appendage 8 with an external thread 9 shown in FIGS. 3 and 4 on which a shaft nut 10 of the shaft 4 is fastened. For centering, the screw assembly 5, 6 includes a positive-fit cone connection. For securing the screw assembly 5, 6, flanging of a flanged collar is also carried out. Here, local material of the shaft nut 10 is shaped into a ring groove 11 shown in FIG. 4.

FIGS. 2 to 4 show the construction and arrangement of the hub appendage 8 that extends axially over a length S starting from the hub 7 and has a diameter D. As shown in FIG. 3, the external thread 9 produced by a circular thread milling method is constructed as a flat trapezoidal thread. According to FIG. 4, a cone 12 or taper spreading out in the direction of the hub 7 connects to the external thread 9 on the end side. The cone 12 provided for centering and interacting with the shaft nut 10 encloses an angle a. between the cone 12 and the hub 7, the hub appendage 8 encloses the ring groove 11 in which, for flanging, a flanged collar 17 shown in FIG. 5 engages with a positive fit and secures the screw assembly 5, 6 against loosening.

In FIGS. 5 and 6, additional details of the shaft 4 and the associated shaft nut 10 are shown. The shaft nut 10 connected integrally to the shaft 4 encloses, in a blind hole-like hole 13, a trapezoidal internal thread 14 constructed complementary to the external thread 9 of the hub appendage 8. A transition zone between the hole 13 and an end side 15 forms a cone-like mount 16 whose design corresponds to the cone 12 of the hub appendage 8. Accordingly, there is agreement between the angle β of the mount 16 and the angle a of the cone 12 of the hub appendage 8.

### LIST OF REFERENCE NUMBERS

1 Turbine rotor
2 Rotor disk
3 Rotor disk
4 Shaft
5 Screw assembly
6 Screw assembly
7 Hub
8 Hub appendage
9 External thread
10 Shaft nut
11 Ring groove
12 Cone
13 Hole
14 Internal thread
15 End side
16 Mount
17 Flanged collar
S Length, hub appendage
D Diameter, hub appendage
α Cone angle, hub appendage
β Mount angle, shaft

1. A turbine rotor of an exhaust gas turbocharger of an internal combustion engine, said turbine rotor comprises at least one rotor disk formed as a turbine wheel or as a compressor wheel and a shaft, said at least one rotor disk and said shaft are made from different materials, the rotor disk including a hub that is permanently connected to the shaft, the shaft is combined with the rotor disk by a screw assembly, said rotor disk including an external thread of on an axially projecting hub appendage that engages a shaft nut connected to the shaft and in an end position, the shaft nut is centered on a cone of the hub appendage.

2. The turbine rotor according to claim 1, wherein the shaft is produced from a steel material and is joined with the rotor disk that is made from an iron-free material.

3. The turbine rotor according to claim 1, wherein the external thread is a flat trapezoidal thread.

4. The turbine rotor according to claim 1, wherein the external thread is produced by a circular thread milling process.

5. The turbine rotor according to claim 1, wherein the hub appendage of the rotor disk has a length S≦9 mm and a diameter D≦8 mm.

6. The turbine rotor according to claim 1, wherein the cone provided for centering the shaft on the hub appendage of the rotor disk has a length of ≦1.2 mm and an angle a of ≦30°.

7. The turbine rotor according to claim 1, wherein the shaft nut includes an internal thread corresponding to the external thread and an end-side mount that is constructed complementary to the cone of the hub appendage.

8. The turbine rotor according to claim 1, wherein for securing the screw assembly, at least a partial flanging of a flanged collar of the shaft material is provided into a ring groove arranged after the external thread on the hub appendage.

9. A method for permanent joining of a shaft to at least one rotor disk of a turbine rotor that is used in an exhaust gas turbocharger of an internal combustion engine, wherein the method comprises the following steps:
a) processing the rotor disk, including:
creating an external thread on an axially projecting hub appendage of the rotor disk by a circular thread milling method,
forming a ring groove in a section of the hub appendage of the rotor disk arranged after the external thread,
forming a cone on the hub appendage between the external thread and the ring groove,
b) processing the shaft, including:
forming an internal thread in the shaft nut by a circular thread milling method,
creating an end-side mount in the shaft nut that corresponds to the cone of the hub appendage, and
c) joining the rotor disk and shaft, including:
screwing the shaft nut on the external thread of the rotor disk,
tightening and centering the screw assembly by a defined tightening torque, wherein the cone of the hub appendage engages in the mount of the shaft nut, and
fixing of the screw assembly by a flanging process in which a flanged collar of the shaft nut is formed into the ring groove of the hub appendage with a positive fit.
